(19) United States
(12) Patent Application Publication
(10) Pub. No.: US 2026/0260261 A1
(43) Pub. Date: Sep. 3, 2026

(54) SYSTEM AND METHOD FOR PREDICTING MARKETING CAMPAIGN PERFORMANCE USING MULTIMODAL AI

(71) Applicant: Francis Kanneh, Santa Monica, CA (US)

(72) Inventor: Francis Kanneh, Santa Monica, CA (US)

(73) Assignee: Francis Kanneh, Santa Monica, CA (US)

(21) Appl. No.: 19/066,181

(22) Filed: Feb. 28, 2025

(51) Int. Cl. G06Q 30/0242; G06Q 30/0204; G06Q 30/0241

(52) U.S. Cl. CPC G06Q 30/0243; G06Q 30/0249; G06Q 30/0204

(57) ABSTRACT

Disclosed are a multimodal AI-powered marketing performance prediction system and method for generating marketing performance predictions. The method includes collecting multimodal data from advertisement platforms and external sources. The collected data is processed using a transformer model to extract sentiment, tone, and keywords. Visual data is analyzed using a vision transformer model to determine composition, branding, and style features. Behavioral data is processed using a machine learning algorithm to identify audience engagement trends. The processed multimodal data is integrated into a multimodal fusion model to predict marketing performance metrics. Based on these metrics and historical trends, strategic marketing recommendations are generated. Predicted strategies are deployed in live campaigns through advertisement platform APIs. Real-time marketing performance data is monitored and analyzed, and the multimodal fusion model is refined based on real-time campaign performance data, ensuring continuous optimization of marketing strategies.

### TECHNOLOGICAL FIELD

The present disclosure generally relates to a multimodal Al-powered marketing performance prediction system and method, and more particularly relates to systems and methods for generating marketing performance predictions using multimodal Al models that analyze text, image, and numerical data through a constrained cross-modal embedding architecture with gradient-based closed-loop model update mechanics.

### BACKGROUND

Marketing professionals rely on data-driven insights to optimize advertising strategies, allocate budgets, and enhance customer engagement. Traditional marketing analytics tools primarily process numerical data such as click-through rates (CTR), conversion rates, and cost-per-click (CPC). However, modern digital campaigns generate vast amounts of heterogeneous data, including textual descriptions of products, ad copy, image-based creatives, and behavioral engagement metrics from social media and search platforms.

Existing marketing analytics solutions often operate in siloed environments, where text, image, and numerical data are analyzed separately. This fragmented approach limits the ability to derive holistic insights, as correlations between different data types remain unrecognized. Additionally, conventional machine learning models used for performance predictions cannot effectively integrate and process multimodal data, resulting in suboptimal recommendations and missed opportunities for campaign optimization. Critically, prior systems fail to provide a unified shared embedding space that maps heterogeneous modalities into a common representational framework, and lack the architectural mechanism to dynamically recalibrate modality-specific weights based on real-time campaign performance feedback.

U.S. Pat. No. 10,887,640B2, issued to Viswanathan Swaminathan et al., discloses systems utilizing an artificial intelligence framework for generating enhanced digital content. The disclosed systems employ a metadata neural network, a summarizer neural network, and a performance neural network to generate metadata for digital content and predict future performance metrics. However, this patent does not disclose a multimodal Al framework that integrates text, image, and numerical data through a shared cross-modal embedding space with multi-head cross-attention and gradient-based closed-loop weight recalibration.

US Patent Application US20190392487A1, filed by Steven Murray Duke et al., discloses a system for the automated creation of digital advertisements. The system processes digital copies of past advertisements and their performance data to generate new advertisement elements. The system does not disclose modality-specific learned linear projection layers, cross-modal attention mechanisms operating across text, visual, and behavioral embeddings simultaneously, or closed-loop gradient-based update of projection parameters using live campaign performance signals as a supervisory signal.

Korean Patent KR102713995B1, filed by VM Insight, describes an AI-based advertising platform providing tailored advertising information to users. This system focuses on AI-driven ad recommendations and user feedback, and does not disclose a shared cross-modal embedding space or the multi-head cross-attention architecture of the present invention.

The rise of deep learning and AI-driven models presents new opportunities to enhance marketing analytics by incorporating multiple data types. Transformer-based models for text processing, vision models for image analysis, and advanced ensemble learning methods for numerical data offer the potential for more accurate predictions. However, there remains a need for a system that maps heterogeneous data modalities into a unified embedding space, computes cross-modal attention across all modalities simultaneously, and closes the prediction loop by recalibrating model parameters using real-time campaign performance signals.

Accordingly, there exists a need for a system and method that can ingest, process, and analyze multimodal marketing data through a constrained cross-modal fusion architecture, generate performance predictions, and provide strategic recommendations to improve marketing outcomes. The present invention addresses these shortcomings by introducing an AI-powered framework that fuses text, image, and numerical data through a shared cross-modal embedding space with multi-head cross-attention and gradient-based closed-loop recalibration.

### BRIEF SUMMARY OF SOME EXAMPLE EMBODIMENTS

In order to solve the foregoing problems, the present disclosure provides a multimodal AI-powered marketing performance prediction system and method, specifically leveraging multimodal artificial intelligence (AI) to analyze and predict marketing performance across text, image, and numerical data modalities through a constrained cross-modal embedding architecture.

In one aspect, a computer-implemented system for generating marketing performance predictions is provided. The computer-implemented system includes a memory and a computer processor. The memory includes a data ingestion module, a multimodal analysis module, a prediction module, a recommendations engine, an A/B testing module, and a feedback loop module.

The multimodal analysis module comprises a text processing sub-module that utilizes a transformer model to generate token-level embeddings representing sentiment data, tone data, and keywords, wherein the token-level embeddings are projected into a shared cross-modal embedding space via a learned linear projection layer. The multimodal analysis module further comprises a visual analysis sub-module that employs a vision transformer model to extract patch-level feature vectors representing composition data, branding data, and style features, wherein the patch-level feature vectors are projected into the shared cross-modal embedding space via a separate learned linear projection layer. The multimodal analysis module further comprises a behavioral analysis sub-module that applies a machine learning model to encode audience engagement signals as behavioral embeddings aligned to the shared cross-modal embedding space, and a cross-modal attention sub-module that computes attention weights across all three projected modalities using a multi-head cross-attention mechanism to produce a unified cross-modal representation.

The prediction module is configured to integrate the unified cross-modal representation into a multimodal fusion model comprising a transformer-based architecture with attention layers to generate marketing performance metrics. The feedback loop module is configured to refine the multimodal fusion model by: (i) computing a modality contribution score for each modality by measuring a performance signal delta between predicted and observed campaign performance metrics; (ii) selectively amplifying or suppressing modality-specific embedding projection parameters based on the computed contribution scores; and (iii) applying gradient-based optimization to the cross-modal attention weights using real-time campaign performance signals as a supervisory signal, thereby recalibrating the shared cross-modal embedding space over successive campaign cycles.

The recommendations engine is configured to generate one or more strategic marketing recommendations based on the marketing performance metrics and historical trends. The A/B testing module is configured to deploy predictive models in live campaigns through advertisement platform application programming interfaces (APIs) and to validate predicted marketing strategies using live campaign performance metrics.

### BRIEF DESCRIPTION OF DRAWINGS

Having thus described exemplary embodiments of the disclosure in general terms, reference will now be made to the accompanying drawings, which are not necessarily drawn to scale, and wherein:

FIG. 1 illustrates a block diagram showing an example architecture of a computer-implemented system for generating marketing performance predictions, in accordance with one or more example embodiments.

FIG. 2A illustrates an exemplary block diagram of the computer-implemented system, in accordance with one or more example embodiments.

FIG. 2B illustrates an operational flow diagram of the computer-implemented system, in accordance with one or more example embodiments.

FIG. 3 illustrates a flowchart of a computer-implemented method for generating marketing performance predictions, in accordance with one or more example embodiments.

FIG. 4 illustrates a diagram of the shared cross-modal embedding space and multi-head cross-attention architecture, in accordance with one or more example embodiments.

FIG. 5 illustrates a diagram of the gradient-based closed-loop feedback recalibration mechanism, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details.

Reference in this specification to ‘one embodiment’ or ‘an embodiment’ means that a particular feature, structure, or characteristic described in connection with the embodiment is included in at least one embodiment of the present disclosure. The appearance of the phrase ‘in one embodiment’ in various places in the specification does not necessarily all refer to the same embodiment, nor are separate or alternative embodiments mutually exclusive of other embodiments.

As defined herein, a ‘computer-readable storage medium,’ which refers to a non-transitory physical storage medium (for example, a volatile or non-volatile memory device), may be differentiated from a ‘computer-readable transmission medium,’ which refers to an electromagnetic signal.

The proposed multimodal AI-powered marketing performance prediction systems and methods are directed to generating marketing performance predictions using multimodal AI models that analyze text, image, and numerical data through a constrained cross-modal fusion architecture. The system ingests multimodal data from various sources, including advertising platforms, real-time streams, and bulk uploads, and processes them through specialized AI models operating in a shared cross-modal embedding space. Text data is analyzed using transformer-based models to generate token-level embeddings capturing sentiment, tone, and key insights. Visual data undergoes vision transformer-based analysis to extract patch-level feature vectors for branding, composition, and style evaluation. Behavioral and numerical data are encoded as behavioral embeddings aligned to the same shared embedding space. A multi-head cross-attention sub-module computes attention weights across all three modalities simultaneously to produce a unified cross-modal representation used for prediction. A feedback loop module closes the prediction cycle by recalibrating the shared embedding space using real-time campaign performance signals through gradient-based optimization.

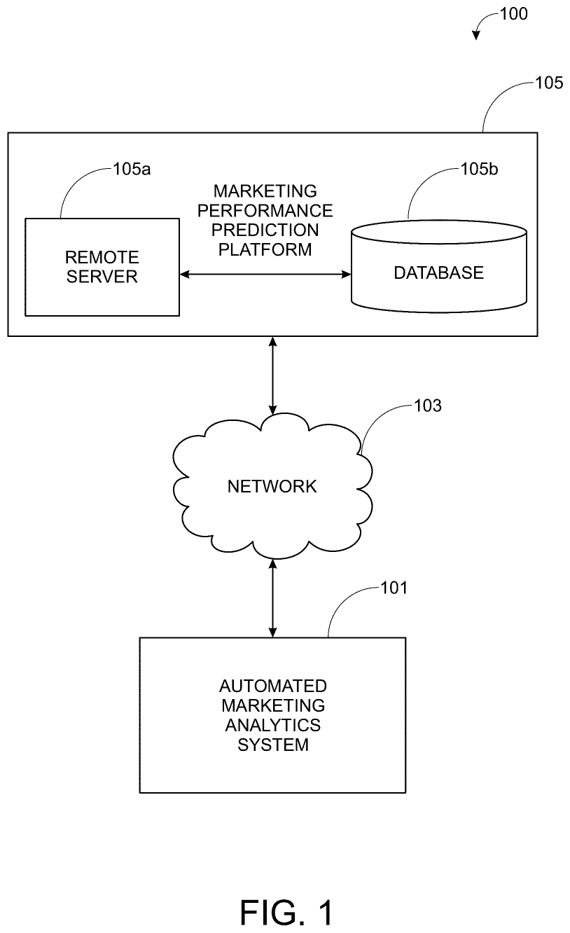

FIG. 1 illustrates a block diagram 100 showing an example architecture of a computer-implemented system 101 for generating marketing performance predictions. As illustrated in FIG. 1, the block diagram 100 may comprise the system 101, a network 103, and a marketing performance prediction platform 105. The marketing performance prediction platform 105 includes a remote server 105a, and a database 105b. In various embodiments, the remote server 105a may receive data from various data sources such as online channels, offline channels, social media, advertisement platforms, and CRM systems over the network 103. The system 101 may be embodied as a cloud-based service, cloud-based application, cloud-based platform, or remote server-based service.

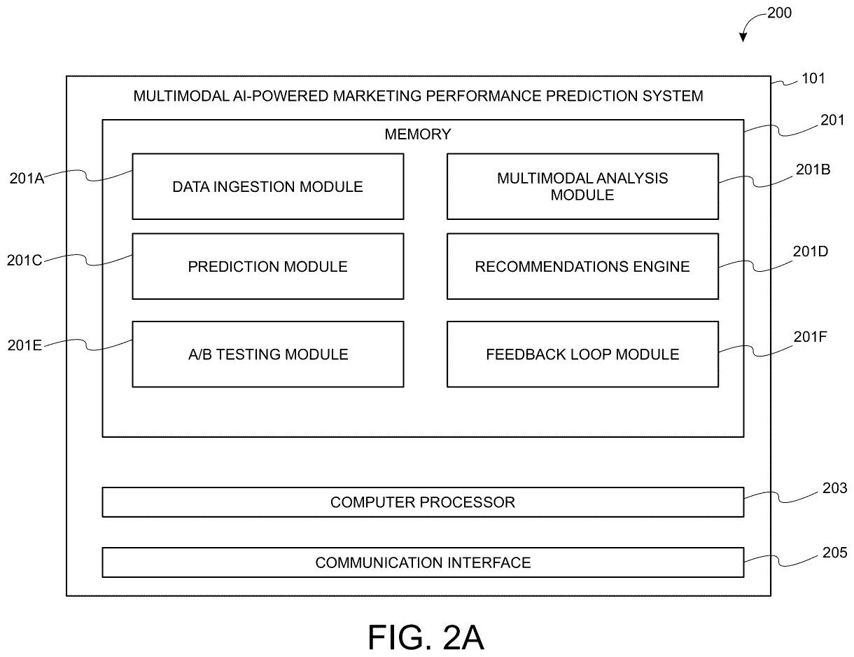

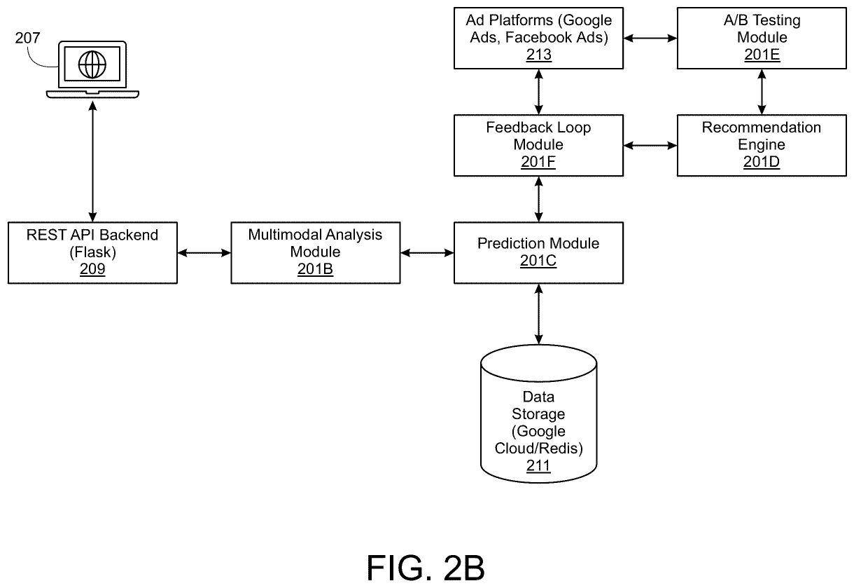

FIG. 2A illustrates an exemplary block diagram 200 of the computer-implemented system. The system 101 includes a memory 201, a computer processor 203, and a communication interface 205. Memory 201 is configured for storing program instructions and further stores a data ingestion module 201A, a multimodal analysis module 201B, a prediction module 201C, a recommendations engine 201D, an A/B testing module 201E, and a feedback loop module 201F. The computer processor 203 is coupled to the memory 201 and executes the program instructions.

In an embodiment, the data ingestion module 201A is configured to collect multimodal data including text, visual, and behavioral metrics from at least one data source. The data ingestion module 201A is configured to retrieve data from one or more advertisement platforms including Google Ads, Facebook Ads, DSPs such as Taboola, and third-party marketing tools. The data ingestion module 201A supports bulk uploads of structured data in CSV format and real-time streaming data from external APIs, and creative content uploaded through the communication interface 205.

The multimodal analysis module 201B is configured to process the multimodal data through a constrained cross-modal embedding architecture. The multimodal analysis module 201B includes a text processing sub-module, a visual analysis sub-module, a behavioral analysis sub-module, and a cross-modal attention sub-module. The text processing sub-module utilizes a transformer model—in an embodiment BERT or a functionally equivalent model—to generate token-level embeddings representing one or more of sentiment data, tone data, and one or more keywords. The token-level embeddings are projected into a shared cross-modal embedding space via a learned linear projection layer. The visual analysis sub-module employs a vision transformer model—in an embodiment CLIP or a functionally equivalent model—to extract patch-level feature vectors representing one or more of composition data, branding data, and style features. The patch-level feature vectors are projected into the shared cross-modal embedding space via a separate learned linear projection layer distinct from the text projection layer. The behavioral analysis sub-module applies a machine learning model—in an embodiment a gradient-boosted tree algorithm—to derive one or more audience engagement signals and performance trends, wherein the audience engagement signals are encoded as behavioral embeddings aligned to the shared cross-modal embedding space. The cross-modal attention sub-module is configured to compute attention weights across the token-level embeddings, patch-level feature vectors, and behavioral embeddings simultaneously using a multi-head cross-attention mechanism to produce a unified cross-modal representation.

In the shared cross-modal embedding space, all three modality-specific embeddings are projected to a common dimensionality. The use of modality-specific learned linear projection layers enables the system to learn, during training, the optimal transformation for each modality independently, while constraining all modalities to contribute to the same representational geometry. This architecture enables the multi-head cross-attention mechanism to compute meaningful cross-modal attention weights that reflect the relative contribution and interaction of each modality to the composite marketing prediction.

The prediction module 201C is configured to integrate the unified cross-modal representation produced by the cross-modal attention sub-module into a multimodal fusion model to generate one or more marketing performance metrics. The multimodal fusion model comprises a transformer-based architecture with attention layers. In an embodiment, the multimodal fusion model employs stacked multi-head attention layers and feed-forward sublayers operating on the unified cross-modal representation. The prediction module 201C is configured to output at least one of the one or more marketing performance metrics selected from click-through rate (CTR), return on investment (ROI), and conversions. The prediction module 201C is configured to perform multimodal data fusion using attention-based neural networks to provide insights by integrating and analyzing data from diverse sources. Unlike conventional regression-based models that rely on fixed-weight relationships, the attention-based architecture dynamically allocates computational focus to the most relevant features within a dataset based on their contextual significance to improve detection of complex, nonlinear patterns in advertising performance metrics.

The recommendations engine 201D is configured to generate one or more strategic marketing recommendations based on the marketing performance metrics and historical trends. The recommendations engine 201D is configured to generate marketing suggestion inputs based on real-time audience segmentation signals derived from the behavioral embeddings. In an embodiment, the recommendations engine 201D analyzes multimodal insights including textual, visual, and behavioral patterns to suggest optimal creative combinations, audience targets, and timing strategies. The recommendations engine 201D is further configured to dynamically reallocate advertisement budgets based on real-time predictive analytics.

The A/B testing module 201E is configured to deploy one or more predictive models based on an AI-driven marketing algorithm in one or more live campaigns through one or more advertisement platform application programming interfaces (APIs). The A/B testing module 201E is configured to validate one or more predicted marketing strategies by comparing cross-modal attention weight distributions across live campaign performance metrics to identify statistically significant performance differentials. The A/B testing module 201E is configured to optimize cross-platform multimodal advertisement performance data by computing modality-specific contribution scores from the cross-modal attention weights to identify which modality drives campaign performance differentials across platforms.

The feedback loop module 201F implements a gradient-based closed-loop recalibration mechanism for the multimodal fusion model. The feedback loop module 201F is configured to refine the multimodal fusion model using real-time marketing performance data through a three-stage process: first, computing a modality contribution score for each of the text, visual, and behavioral modalities by measuring a performance signal delta between predicted and observed campaign performance metrics; second, selectively amplifying or suppressing modality-specific embedding projection parameters according to the computed modality contribution scores; and third, applying gradient-based optimization to the cross-modal attention weights using the real-time campaign performance signals as a supervisory signal, thereby recalibrating the shared cross-modal embedding space and differentially weighting modality contributions to improve predictive accuracy over successive campaign cycles. The feedback loop module 201F is further configured to update and retrain the multimodal fusion model using live campaign data to enhance predictive accuracy.

In an embodiment, the modality contribution score for each modality is computed as a function of the magnitude of the performance signal delta-the difference between the predicted campaign performance metric output by the fusion model and the observed real-world campaign performance metric returned from the advertisement platform APIs. A modality that consistently predicts outcomes accurately in a given campaign context receives a higher contribution score, causing the gradient-based optimization to amplify the corresponding projection parameters. A modality that introduces predictive noise receives a lower contribution score, causing suppression of the corresponding projection parameters. This closed-loop recalibration ensures that the shared cross-modal embedding space continuously adapts to the statistical patterns of live campaign performance data.

FIG. 2B illustrates an operational flow diagram of the computer-implemented system. The frontend dashboard 207 is built using React to provide real-time feedback dashboards. The data storage 211 utilizes AWS S3 or Google Cloud Storage to store both structured and unstructured campaign data. The ad platforms 213 (e.g., Google Ads, Facebook Ads) are connected to the A/B testing module 201E and the feedback loop module 201F to facilitate real-time monitoring and adjustments.

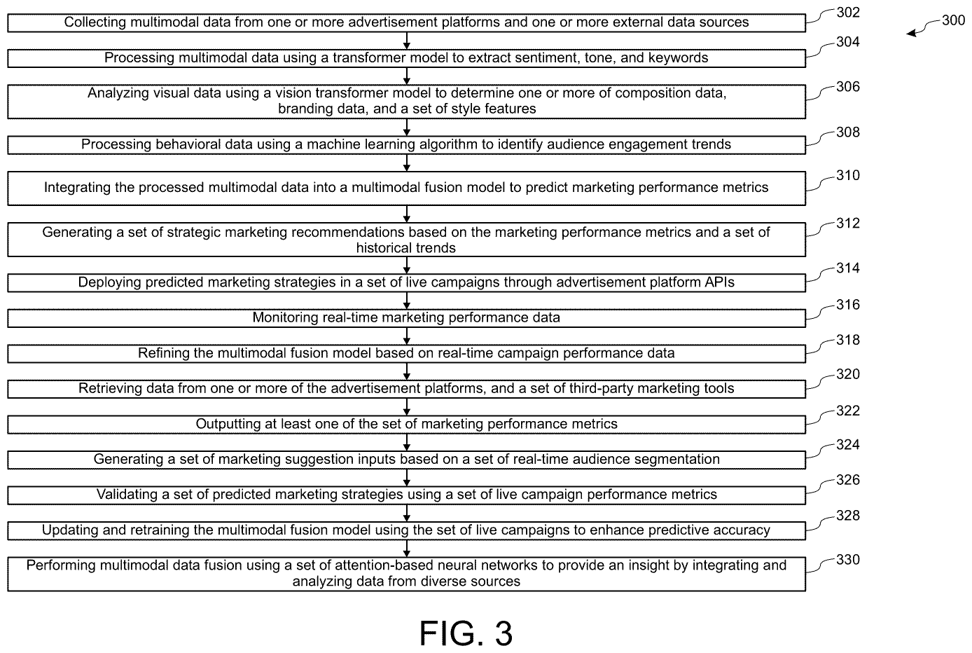

FIG. 3 illustrates a flowchart of a computer-implemented method 300 for generating marketing performance predictions. Method 300 includes step 302 of collecting multimodal data from one or more advertisement platforms and external data sources. Step 304 involves generating token-level embeddings from multimodal data using a transformer model. Step 306 involves generating patch-level feature vectors from visual data using a vision transformer model. Step 308 involves encoding behavioral data as behavioral embeddings using a machine learning algorithm. Step 310 involves projecting the token-level embeddings, patch-level feature vectors, and behavioral embeddings into a shared cross-modal embedding space via modality-specific learned linear projection layers. Step 312 involves computing cross-modal attention weights across the projected embeddings using a multi-head cross-attention mechanism to produce a unified cross-modal representation. Step 314 involves integrating the unified cross-modal representation into a multimodal fusion model to predict marketing performance metrics. Step 316 involves generating strategic marketing recommendations. Step 318 involves deploying predicted marketing strategies through advertisement platform APIs. Step 320 involves monitoring real-time campaign performance signals. Step 322 involves updating the multimodal fusion model through the gradient-based closed-loop recalibration process. Additional steps include retrieving data from advertisement platforms and third-party marketing tools (step 324); outputting marketing performance metrics (step 326); generating marketing suggestion inputs based on audience segmentation signals derived from behavioral embeddings (step 328); validating predicted marketing strategies by comparing cross-modal attention weight distributions (step 330); and dynamically reallocating advertisement budget based on real-time predictive analytics (step 332).

FIG. 4 illustrates the shared cross-modal embedding space architecture. The diagram shows the three modality-specific input streams (text tokens, image patches, behavioral engagement vectors) being processed by their respective models (transformer, vision transformer, gradient-boosted tree) and projected into the shared cross-modal embedding space by three independent learned linear projection layers. The shared space feeds into the multi-head cross-attention sub-module, which computes pairwise and multi-way attention weights across all three modality streams simultaneously. The output of the multi-head cross-attention sub-module is the unified cross-modal representation, which serves as input to the prediction module's fusion model.

FIG. 5 illustrates the gradient-based closed-loop feedback recalibration mechanism. The diagram shows the prediction module outputting a predicted campaign performance metric, which is compared against the observed campaign performance metric returned from the advertisement platform APIs. The performance signal delta is computed for each modality, generating modality contribution scores. These contribution scores are used to selectively amplify or suppress the modality-specific embedding projection parameters. Simultaneously, gradient-based optimization is applied to the cross-modal attention weights using the performance signal delta as a supervisory signal. The recalibrated projection parameters and attention weights are fed back into the shared cross-modal embedding space for the next prediction cycle.

The present disclosure further provides various exemplary use cases where the multimodal AI-powered marketing performance prediction system may be implemented. In one embodiment, the system assists a B2B SaaS company in optimizing advertising effectiveness by predicting the optimal combination of headlines, images, and call-to-action elements before campaign deployment. In another embodiment, the system is employed by a gaming company to forecast the highest-performing ad format across social media platforms. In yet another embodiment, the system is utilized by an automotive brand conducting campaigns across multiple digital platforms to automatically generate budget allocation recommendations to maximize ROI.

According to an embodiment, the multimodal Al-powered marketing performance prediction system integrates with third-party advertising platforms via their respective APIs, including the Facebook Ads API, Google Ads API, and Amazon advertising API. This integration enables seamless access to structured and continuously updated ad performance data, facilitating data-driven decision-making for campaign optimization.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims.

1. A computer-implemented system, comprising:
a memory for storing program instructions;
a computer processor coupled to the memory and executing the program instructions, wherein the memory comprises:
a data ingestion module configured to collect multimodal data from at least one data source;
a multimodal analysis module configured to process the multimodal data, wherein the multimodal analysis module comprises:
a text processing sub-module that utilizes a transformer model to generate token-level embeddings representing one or more of sentiment data, tone data, and one or more keywords, wherein the token-level embeddings are projected into a shared cross-modal embedding space via a learned linear projection layer;
a visual analysis sub-module that employs a vision transformer model to extract patch-level feature vectors representing one or more of composition data, branding data, and one or more style features, wherein the patch-level feature vectors are projected into the shared cross-modal embedding space via a separate learned linear projection layer;
a behavioral analysis sub-module configured to apply a machine learning model to derive one or more audience engagement signals and one or more performance trends, wherein the audience engagement signals are encoded as behavioral embeddings aligned to the shared cross-modal embedding space; and
a cross-modal attention sub-module configured to compute attention weights across the token-level embeddings, patch-level feature vectors, and behavioral embeddings using a multi-head cross-attention mechanism to produce a unified cross-modal representation;
a prediction module configured to integrate the unified cross-modal representation into a transformer-based multimodal fusion model comprising stacked multi-head attention layers and feed-forward sublayers to generate one or more marketing performance metrics;
a recommendations engine configured to generate one or more strategic marketing recommendations based on the marketing performance metrics and one or more historical trends;
an A/B testing module configured to deploy campaign variants generated by the transformer-based multimodal fusion model in one or more live campaigns through one or more advertisement platform application programming interfaces (APIs), wherein each campaign variant corresponds to a distinct predicted marketing performance metric output by the transformer-based multimodal fusion model; and
a feedback loop module configured to refine the transformer-based multimodal fusion model by: (i) computing a modality contribution score for each of the text, visual, and behavioral modalities by measuring a performance signal delta between predicted and observed campaign performance metrics; (ii) selectively amplifying or suppressing modality-specific embedding projection parameters according to the computed modality contribution scores; and (iii) applying gradient-based optimization to the cross-modal attention weights using the real-time campaign performance signals as a supervisory signal, thereby recalibrating the shared cross-modal embedding space and differentially weighting modality contributions to improve predictive accuracy over successive campaign cycles.

2. The computer-implemented system of claim 1, wherein the data ingestion module is configured to retrieve data from one or more of the advertisement platforms, and one or more third-party marketing tools.

3. The computer-implemented system of claim 1, wherein the prediction module is configured to output at least one of the one or more marketing performance metrics.

4. The computer-implemented system of claim 1, wherein the recommendations engine is configured to generate one or more marketing suggestion inputs based on one or more real-time audience segmentation signals derived from the behavioral embeddings.

5. The computer-implemented system of claim 1, wherein the A/B testing module is configured to validate one or more predicted marketing strategies by comparing cross-modal attention weight distributions across live campaign performance metrics to identify statistically significant performance differentials.

6. The computer-implemented system of claim 1, wherein the feedback loop module is configured to compute modality contribution scores by measuring performance signal deltas between predicted and observed campaign metrics for each of the text, visual, and behavioral modalities, and to apply gradient-based optimization to the cross-modal attention weights using the campaign performance signals as a supervisory signal, wherein modality-specific embedding projection parameters are selectively amplified or suppressed based on the computed contribution scores to differentially weight modality contributions over successive campaign cycles.

7. The computer-implemented system of claim 1, wherein the prediction module is configured to perform multimodal data fusion using the transformer-based multimodal fusion model comprising stacked multi-head attention layers and feed-forward sublayers operating on the unified cross-modal representation to generate the marketing performance metrics.

8. The computer-implemented system of claim 1, wherein the recommendations engine is configured to dynamically reallocate an advertisement budget based on real-time predictive analytics.

9. The computer-implemented system of claim 1, wherein the A/B testing module is configured to optimize cross-platform multimodal advertisement performance data by computing modality-specific contribution scores from the cross-modal attention weights to identify which modality drives campaign performance differentials across platforms.

17. The computer-implemented system of claim 1, wherein the one or more predicted marketing performance metrics comprise one or more of click-through rate, return on investment, and conversions.

10. A computer-implemented method, comprising:
collecting, by a computer, multimodal data from one or more advertisement platforms and one or more external data sources;
generating, by the computer, token-level embeddings from the multimodal data using a transformer model to represent one or more of sentiment data, tone data, and one or more keywords;
generating, by the computer, patch-level feature vectors from visual data using a vision transformer model to represent one or more of composition data, branding data, and one or more style features;
encoding, by the computer, behavioral data as behavioral embeddings using a machine learning algorithm to represent audience engagement signals and performance trends;
projecting, by the computer, the token-level embeddings, patch-level feature vectors, and behavioral embeddings into a shared cross-modal embedding space via modality-specific learned linear projection layers;
computing, by the computer, cross-modal attention weights across the projected embeddings using a multi-head cross-attention mechanism to produce a unified cross-modal representation;
integrating, by the computer, the unified cross-modal representation into a transformer-based multimodal fusion model comprising stacked multi-head attention layers and feed-forward sublayers to predict marketing performance metrics;
generating, by the computer, one or more strategic marketing recommendations based on the marketing performance metrics and one or more historical trends;
deploying, by the computer, campaign variants generated by the transformer-based multimodal fusion model in one or more live campaigns through one or more advertisement platform APIs, wherein each campaign variant corresponds to a distinct predicted marketing performance metric output by the transformer-based multimodal fusion model; and
monitoring, by the computer, real-time campaign performance signals; and
updating, by the computer, the transformer-based multimodal fusion model by: (i) computing a modality contribution score for each of the text, visual, and behavioral modalities by measuring a performance signal delta between predicted and observed campaign performance metrics; (ii) selectively amplifying or suppressing modality-specific embedding projection parameters according to the computed modality contribution scores; and (iii) applying gradient-based optimization to the cross-modal attention weights using the real-time campaign performance signals as a supervisory signal, thereby recalibrating the shared cross-modal embedding space and differentially weighting modality contributions.

11. The computer-implemented method of claim 10, further comprising:
retrieving, by the computer, data from one or more of the advertisement platforms and one or more third-party marketing tools; and outputting, by the computer, at least one of the marketing performance metrics.

12. The computer-implemented method of claim 10, further comprising:
generating, by the computer, one or more marketing suggestion inputs based on real-time audience segmentation signals derived from the behavioral embeddings.

13. The computer-implemented method of claim 10, further comprising:
validating, by the computer, one or more predicted marketing strategies by comparing cross-modal attention weight distributions across live campaign performance metrics to identify statistically significant performance differentials.

14. The computer-implemented method of claim 10, further comprising:
applying, by the computer, gradient-based optimization to the cross-modal attention weights using real-time campaign performance signals as a supervisory signal to update and retrain the transformer-based multimodal fusion model, thereby enhancing predictive accuracy.

15. The computer-implemented method of claim 10, further comprising:
performing, by the computer, multimodal data fusion using stacked multi-head attention layers operating on the unified cross-modal representation to provide an integrated marketing insight by computing modality interaction scores across text, visual, and behavioral data sources.

16. A computer program product for generating marketing performance predictions, the computer program product comprising:
one or more computer-readable storage media; and
program instructions stored on the one or more computer-readable storage media to perform operations comprising:
collecting multimodal data from one or more advertisement platforms and one or more external data sources;
generating token-level embeddings using a transformer model to represent one or more of sentiment data, tone data, and one or more keywords;
generating patch-level feature vectors using a vision transformer model to represent one or more of composition data, branding data, and one or more style features;
encoding behavioral data as behavioral embeddings to represent audience engagement signals;
projecting the token-level embeddings, patch-level feature vectors, and behavioral embeddings into a shared cross-modal embedding space via modality-specific learned linear projection layers;
computing cross-modal attention weights across the projected embeddings using a multi-head cross-attention mechanism to produce a unified cross-modal representation;
integrating the unified cross-modal representation into a transformer-based multimodal fusion model comprising stacked multi-head attention layers and feed-forward sublayers to predict marketing performance metrics;
generating one or more strategic marketing recommendations based on the marketing performance metrics and one or more historical trends;
deploying campaign variants generated by the transformer-based multimodal fusion model in one or more live campaigns through one or more advertisement platform APIs, wherein each campaign variant corresponds to a distinct predicted marketing performance metric output by the transformer-based multimodal fusion model; and
monitoring real-time campaign performance signals; and
updating the transformer-based multimodal fusion model by: (i) computing a modality contribution score for each of the text, visual, and behavioral modalities by measuring a performance signal delta between predicted and observed campaign performance metrics; (ii) selectively amplifying or suppressing modality-specific embedding projection parameters according to the computed modality contribution scores; and (iii) applying gradient-based optimization to the cross-modal attention weights using the real-time campaign performance signals as a supervisory signal, thereby recalibrating the shared cross-modal embedding space and differentially weighting modality contributions.
